(19) United States
(12) Patent Application Publication
(10) Pub. No.: US 2011/0032725 A1
(43) Pub. Date: Feb. 10, 2011

(54) Optical Module and Optical Unit

(76) Inventor: Fumio Nagai, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/988,191

(22) PCT Filed: Mar. 17, 2009
(86) PCT No.: PCT/JP2009/055134

§ 371 Date: Oct. 15, 2010

(30) Foreign Application Priority Data
Apr. 18, 2008 (JP) 2008-108832

(51) Int. Cl. G02B 27/18; H01S 3/00

(52) U.S. Cl. 362/553; 362/259

(57) ABSTRACT

A semiconductor laser used as a light source of an optical module is susceptible to the return light from the lens surface. The problem has been conventionally solved by offsetting the optical axis of a lens and the optical axis of a semiconductor laser, but a high-precision and costly process for adjusting the positioning is required. An optical module and an optical unit, wherein the oscillation state of a semiconductor laser can be limited in the range of normal characteristics at a low cost, are provided by proposing a lens which eliminates the need for adjusting the positioning because there is little return light. As a first lens on which the light exiting a semiconductor laser impinges at first, a lens having an optical surface whose convex surface faces toward the semiconductor laser side is employed so that the light is diverged thus reducing the intensity of light returning to the semiconductor laser.

### FIELD OF THE INVENTION

The present invention relates to an optical module and optical unit that join light of a laser light source to an optical fiber, emit the light to a space, or apply such processing as modulation or conversion of wavelength to the light.

### BACKGROUND OF THE INVENTION

The semiconductor laser used as the light source of an optical module is known to be generally susceptible to return light. If light passes through some path to return to the active layer wherein the semiconductor laser is in the state of oscillation, the return light causes stimulated emission. This will reduce the laser gain, and will cause the relationship between the input current and laser output or the state of oscillation spectrum to be deviated from the normal characteristic range. Thus, to maintain the oscillation state of the semiconductor laser within the normal characteristic range, it has been essential to minimize the input of return light in the conventional art.

The countermeasures against the return light in an optical module using a semiconductor laser are found in the technique disclosed in the Patent Literature 1. In an optical module made up of an integrated combination of the laser mounted on a substrate, an optical fiber and a combination optical system for inputting the laser light into the aperture on one end face of the optical fiber, the optical axis of the lens closest to the laser will not meet the optical axis of the laser light in the optical components of the combination optical system. This arrangement reduces the intensity of the return light coming from the lens to the laser, thereby stabilizing the laser operation and the characteristics of the optical module.

Patent Literature 1: Japanese Unexamined Patent Application Publication No. Hei 11 (1999)-295559

### DISCLOSURE OF THE INVENTION

### Problems to be Solved by the Invention

In the optical module disclosed in the Patent Literature 1, if there is a great offset between the optical axis of the lens closest to the semiconductor laser and the optical axis of the semiconductor laser, aberration occurs to the light emanating from the lens. If the offset is insufficient, the intensity of the return light will be excessive. This requires the offset to be kept within a prescribed small range. This requirement cannot be met by the commonly practiced positioning process. A very costly high-precision positioning process must be installed in order to meet this requirement.

Thus, the object of the present invention is to provide a low-cost optical module and optical unit wherein the oscillation state of the semiconductor laser can be kept within the normal characteristic range, by providing a lens closest to the semiconductor laser and a lens that eliminates the need of adjusting the position with respect to the semiconductor laser.

### Means for Solving the Problems

The above-mentioned object can be achieved by the following inventions.

1. An optical module comprising a laser light source and at least one lens on which a light emitted from the laser light source enters, wherein an optical axis of the laser light source and an optical axis of the lens approximately agree with each other and, among lenses on which the emitted light enters, a lens on which the emitted light enters first (herein after referred to as “a first lens”) contains an optical surface whose convex surface faces the light source side.

2. The optical module described in Structure 1 wherein the distance from an outgoing aperture of the laser light source to the optical surface of the first lens on the laser light source side does not exceed 8 mm.

3. The optical module described in Structure 1 or 2 wherein the following conditional expression is satisfied where “r” represents a paraxial curvature radius of the optical surface of the first lens on the laser light source side and “f” represents a focal distance of the first lens:

0.50<r/f<6.0 (1)

4. The optical module described in any one of the Structures 1 to 3 wherein the following conditional expression is satisfied where “d” represents an on-axis thickness of the first lens and “f” represents a focal distance of the first lens:

0.40<d/f<1.3 (2)

5. The optical module described in any one of the Structures 1 to 4 wherein the first lens is a collimating lens.

6. The optical module described in any one of the Structures 1 to 5 wherein the optical surface of the first lens on the light source side is spherical.

7. An optical unit including: the optical module described in any one of the Structures 1 to 6; and a waveguide structure for combining and outputting the laser beams coming out of the optical module.

### EFFECTS OF THE INVENTION

According to the present invention, the return light reflected from the optical surface onto the light source side is diverged so that the light entering the outgoing aperture of the light source is much reduced. This arrangement eliminates the need of using a very costly high-precision positioning process and minimizes the impact of the return light upon the oscillation characteristic of a semiconductor laser.

### BRIEF DESCRIPTION OF THE DRAWINGS

FIG. 1 is a diagram representing the overview of an optical module;

FIG. 2 is another diagram representing the overview of an optical module;

FIG. 3 is a diagram representing the overview of an optical unit;

FIG. 4 is a diagram showing how the light is reflected by a lens;

FIG. 5 is another diagram showing how the light is reflected by a lens;

FIG. 6 is a diagram showing how the light coming out of the waveguide structure is reflected by a lens;

FIG. 7 is a diagram representing the relationship between the distance between the semiconductor laser and lens, and the intensity of the return light;

FIG. 8 is a diagram representing the relationship between the r/f and intensity of the return light;

FIG. 9 is another diagram representing the relationship between the r/f and intensity of the return light;

FIG. 10 is a diagram showing that the r/f is an appropriate indicator;

FIG. 11 is a diagram showing how light is reflected by a lens;

FIG. 12 is an explanatory diagram showing the lens configuration in embodiment 4; and

FIG. 13 is an explanatory diagram showing the lens configuration in embodiment 5.

### DESCRIPTION OF REFERENCE NUMERALS

1, 2, 3 Optical module
11 Semiconductor laser
12, 41 Lens
21 Collimating lens
13 Optical fiber
31 Waveguide
51, 62, 71 First lens
61 Waveguide structure

### DETAILED DESCRIPTION OF THE PREFERRED EMBODIMENT

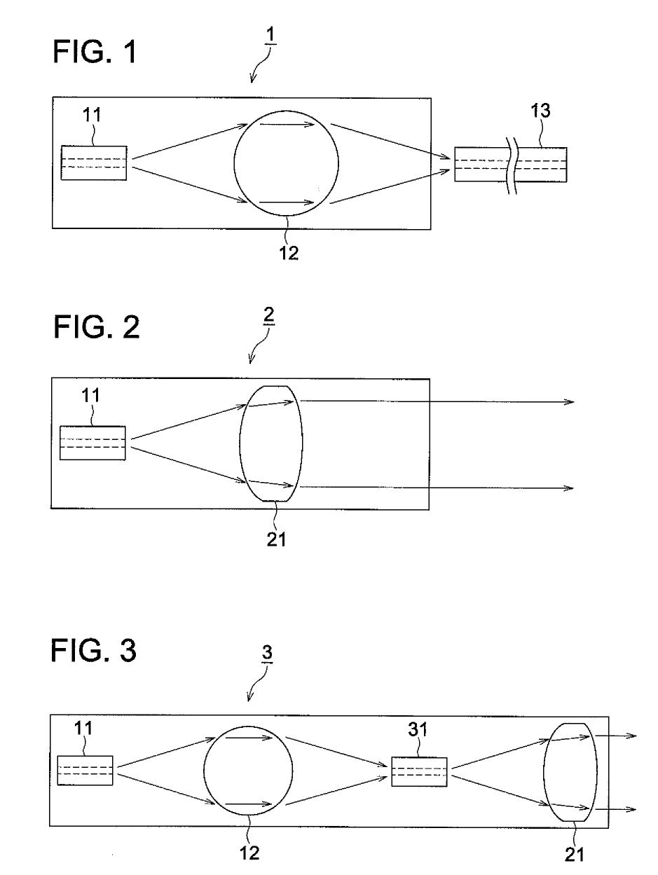

The following describes the present invention with reference to embodiments, without the present invention being restricted thereto. In the first place, the first embodiment will be described. FIGS. 1 through 3 show examples of optical modules. The optical module of FIG. 1 has a function of ensuring that the light emanating from the semiconductor laser 11 is joined to the optical fiber 13 through a lens 12. The optical module 2 of FIG. 2 ensures that the light emanating from the semiconductor laser 11 is outputted as a collimated light to the external space by the collimating lens 21. The optical unit 3 of FIG. 3 uses the optical module of FIG. 1 to ensure that the light emanating from the semiconductor laser 11 is joined to the waveguide 31 through the lens 12. After the light has been subjected to such processing as modulation or conversion of wavelength by means of the waveguide 31, the optical unit 3 uses the collimating lens 21 to output this light to the external space.

The waveguide can be defined as a waveguide structure for confining and transmitting the light in the direction perpendicular to the light traveling direction. Another embodiment of this waveguide structure is an optical fiber. The device with a waveguide mounted thereon includes a waveguide type SHG (second harmonic generation) device.

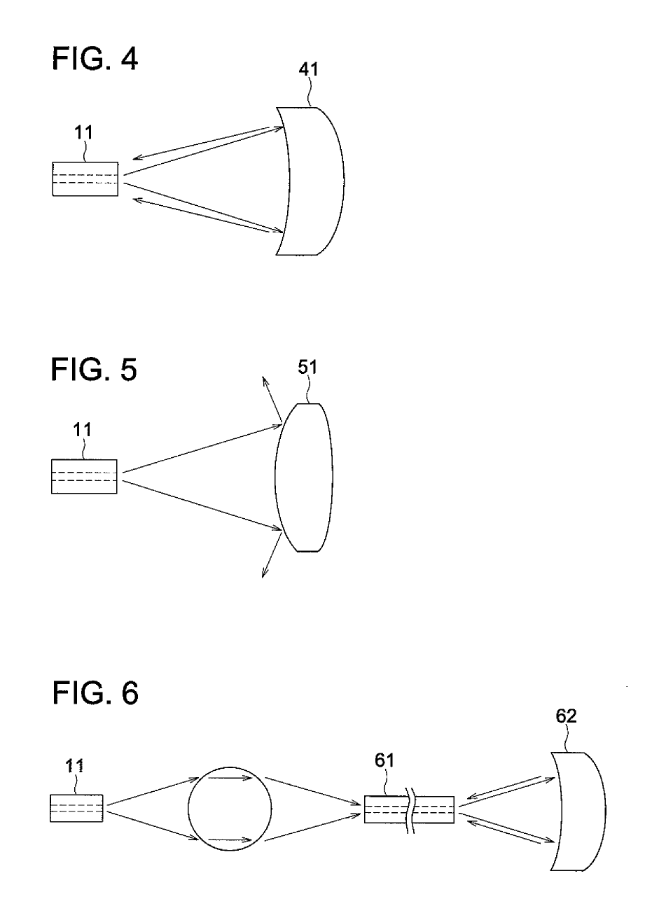

If the light diverged from the semiconductor laser 11 as a light source enters the incident lens 41 (also called the first lens) and has the concave optical surface facing the semiconductor laser 11 as shown in FIG. 4, the light diverging from the semiconductor laser 11 is reflected to be converged on the optical surface. Since this causes much light to go back to the outgoing aperture of the light from the semiconductor laser 11, much light enters the resonator for laser oscillation, and this causes stimulated emission inside the laser gain medium, with the result that unstable oscillation of the laser beam occurs. Unstable oscillation of the laser beam causes the mode hopping wherein the vertical mode of the laser shifts to another mode, or mode contention wherein the single vertical mode shifts to a plurality of modes or fluctuation of light intensity occurs among a plurality of modes, for example. Such disadvantages occur to the semiconductor laser. However, as shown in FIG. 5, in the optical module of the present embodiment, the first lens 51 has its convex optical surface facing the semiconductor laser 11. This ensures that the light reflected on the optical surface is diverged more extensively than the light emanating from the semiconductor laser 11. This procedure greatly reduces the intensity of the light returned to the outgoing aperture of the semiconductor laser 11, and minimizes the impact of the laser beam upon oscillation. This minimizes the above-mentioned disadvantages to the optical module such as mode hopping or mode contention, and ensures laser oscillation with stable oscillation characteristics.

As shown in FIG. 6, when the light emanating from the semiconductor laser 11 enters the waveguide structure 61 represented by an optical fiber or waveguide, the light emanating from the waveguide structure 61 is reflected by the first lens 62 and is again inputted to the waveguide structure 61 to comeback to the semiconductor laser 11. It goes without saying that, when the light having entered the first lens 62 through the waveguide structure 61 becomes the return light, the invention of the present embodiment also provides the same advantages. In the following description, the light emanating from the semiconductor laser includes the light outputted from the semiconductor laser through the waveguide structure, as described above.

The following describes the second embodiment. The light emanating from the semiconductor laser is reflected and turned into the return light by the optical surface on the semiconductor laser side of the first lens that the light enters. When the reflecting surface is flat, the intensity of the return light entering the outgoing aperture of the semiconductor laser is decreased as the distance between the semiconductor laser and lens is increased. In an optical module using a semiconductor laser, it is a common practice to modify the intensity of the laser light at a high frequency. However, the return light changes the intensity of the laser light and adversely affects the control of the intensity of the laser light. The upper limit of the intensity of the return light that does not change the intensity of laser light is said to be about 70 dB lower than the intensity of the outgoing light.

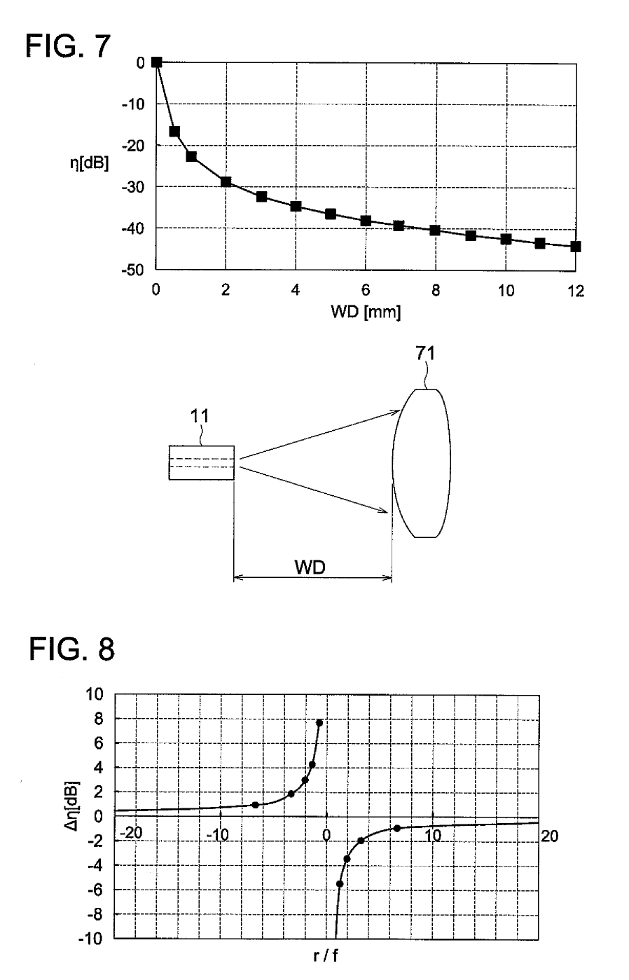

To reduce the intensity of the return light, nonreflective coating is often applied to the optical surface of the lens. In the nonreflective coating, the optical surface of the lens is provided with multiple layers which reflect the incoming light by shilling the phase of this light by half the wavelength, in such a way that the beams of light reflected by each layer cancel one another, and overall reduction of the intensity of the reflected light is achieved. When the nonreflective coating is used, the reflected light can be removed almost completely in ideal terms. However, in actual practice, the incoming light has a prescribed length and there are variations in coat production. Because of these factors, the maximum possible reduction of the intensity of the reflected light is said to be about 30 dB. Thus, to reduce the intensity of the return light by 70 dB, a further 40 dB reduction is essential. In the meantime, the intensity of the return light mainly depends on the shape of the outgoing aperture of the semiconductor laser, the distance WD (working distance) from the outgoing aperture of the semiconductor laser to the lens surface on the semiconductor laser side, and the shape of the optical surface of the lens. The outgoing aperture of the semiconductor laser has a width of about several microns, independently of the semiconductor laser. The surface shape of the lens on the semiconductor laser side is almost flat in most cases. When these conditions of the optical system are taken into account, the intensity of the return light can be said to depend mainly on the WD. Thus, calculation was made to get the value of WD for reducing the intensity of the return light by 40 dB. The calculation is based on the following assumption: The light emanating from the outgoing aperture of the semiconductor laser is a Gaussian beam, and the outgoing aperture is assumed as a circle having a radius of 5 μm in terms of cross section geometry. The waist diameter of the Gaussian beam is 5 μm. These values are representative in the optical module using a semiconductor laser. When the outgoing light is completely reflected by the lens surface on the semiconductor laser side, calculation is made to find out the intensity of the return light entering the outgoing aperture of the semiconductor laser. As described above, the optical surface of the lens is assumed as flat. The wavelength of the outgoing light is assumed as 1.31 μm. FIG. 7 shows the result of calculation. In FIG. 7, WD represents the distance between the outgoing aperture of the semiconductor laser 11 and the optical surface of the first lens 71 on the semiconductor laser 11 side, as described above. The vertical axis provides a logarithmic representation of the ratio of the intensity of the return light with respect to the intensity of the outgoing light. The result of this calculation demonstrates that the WD for reducing 40 dB is 8 mm.

Thus, when the optical surface of the first lens is flat, the WD of 8 mm is required. When the optical surface of the first lens is convex, the WD can be reduced to below 8 mm because not much light returns to the semiconductor laser 11. The above discussion demonstrates that the intensity of the return light can be reduced to 70 dB if the optical surface of the first lens on the semiconductor laser 11 side is convex, nonreflective coating is provided, and the WD is kept at 8 mm or below. Thus, the oscillation characteristics of the semiconductor laser can be stabilized.

The following describes the third embodiment. In the first place, the following explains the formula r/f as an indicator showing the impact of the return light upon the semiconductor laser. In this formula, “r” represents the curvature radius of the optical surface of the first lens on the semiconductor laser side, and “f” represents the focal distance of the first lens. If an optical module is produced with the indicator r/f kept within the range defined by the following conditional expression (1), it is possible to provide an optical module characterized by a compact and lightweight structure, simplified assembling and adjustment, and minimized impact of the return light.

0.50<r/f<6.0 (1)

The following describes the validity of the conditional expression (1): In the first place, the lower limit of the indicator r/f will be explained. If the radius r is smaller, the light emanating from the semiconductor laser is diverged on the optical surface to a greater degree. This reduces the intensity of the light entering the outgoing aperture, and decreases the impact on the laser oscillation. However, a smaller radius r will cause greater spherical aberration to occur. To prevent this, the optical surface is made aspherical, for example, to reduce the aspherical surface. However; there is a limit to the effort of reducing the spherical aberration by making the optical surface an aspherical surface. Thus, to ensure that the spherical aberration occurring to the first lens is maintained at a level permitting commercial use, the radius r must be kept equal to or greater than a prescribed value. From the above discussion, it can be concluded that the radius r has a lower limit.

In the meantime, when the focal distance f is longer, the distance between the semiconductor laser and first lens will also be longer. Thus, the light returning from the optical surface of the first lens entered by the light diverged from the semiconductor laser is diverged to a greater degree. Since the intensity of the light entering the outgoing aperture is reduced, the impact on the laser oscillation will also be reduced. However, when consideration is given to a compact and lightweight structure of the optical module, there is a limit to the effort of increasing the focal distance f of the lens. Thus, the focal distance f has a prescribed upper limit. From the above discussion, it can be concluded that the radius r has a lower limit. If a value equal to or greater than the lower limit is used, it is possible to reduce the spherical aberration occurring to the lens, hence the impact of the return light. This allows the optical surface to be designed in a compact and lightweight structure. To use specific values, it will be appropriate to use a combination wherein the lower limit of the r is 1.2, and the upper limit of the f is 2.5. Thus, the lower limit of the indicator r/f is preferably 0.5.

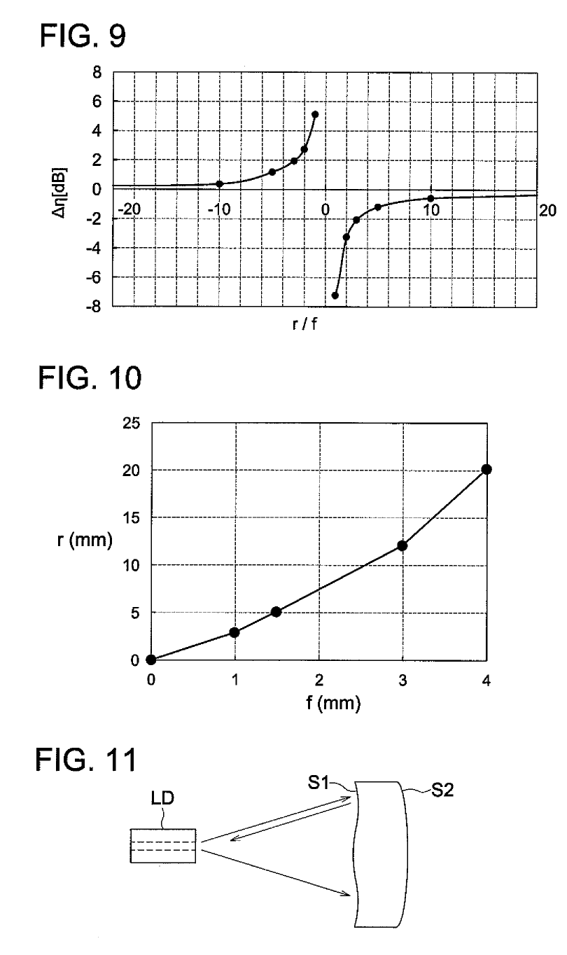

The following describes the upper limit of the indicator r/f. When the focal distance f is smaller, the distance between the semiconductor laser and lens will be shorter. This will be easier to meet the requirements for a compact and lightweight structure. However, as the structure is smaller, there will be greater difficulties in assembling and adjustment. This shows that the focal distance f has a lower limit. Further, if the focal distance is shorter, there will be a greater intensity in the light returning from the lens to the semiconductor laser. In the meantime, as the radius r is greater, there will be greater intensity in the light returning from the optical surface of the lens. This shows that the radius r must be reduced below a prescribed value. Thus, the radius r has an upper limit. The following describes an example of the calculation. The light coming out of the outgoing aperture of the semiconductor laser is assumed as a Gaussian beam, and the beam waist radius is assumed as 2 μm. Calculation is made to find out the intensity of the return light entering the outgoing aperture of the semiconductor laser when the outgoing light is reflected on the surface of the first lens on the semiconductor laser side. For ease of explanation, the reflectivity on the optical surface of the lens is considered as 100%, and the optical surface of the lens is assumed as aspherical. Also assume that the wavelength of the outgoing light is 1.06 μm, the refractive index is 1.58, on-axis thickness of the lens is 1.5 mm, and focal distance f is 1.5 mm. The above-mentioned calculation condition will be called the calculation condition 1. The result of calculation is given in FIG. 8. In this case, the indicator r/f is plotted on the horizontal axis. For the intensity of the return light joined to the outgoing aperture, the vertical axis represents the intensity Δη of the return light expressed in terms of the ratio with reference to the intensity of light when the optical surface of the lens is flat. The vertical axis is shown in logarithmic representation. As a result, when the tolerance of the intensity of light Δη of the return light is −1 dB, the indicator r/f is about 6. For the calculation conditions, the result of this calculation is shown in FIG. 9 when only the focal distance f is changed to 1.0 mm. In this case as well, when the tolerance of the intensity η of the return light is −1 dB, the indicator r/f is about 6. Thus, independently of the focal distance f, the indicator r/f is about 6 wherein the tolerance of the intensity Δη of the return light is −1 dB.

The following shows that the value r/f is appropriate as an indicator that represents the quantity of the intensity of return light joining with the outgoing aperture of the semiconductor laser. For this end, the following demonstrates that, when the value for the indicator r/f is constant, the quantity of the intensity of return light joining with the outgoing aperture of the semiconductor laser is constant, independently of the modification in the values for radius r and focal distance f. FIG. 10 shows an example of calculating the relationship between the focal distance f and radius r based on the same calculation condition as the above-mentioned calculation condition 1, when the quantity of the intensity of the return light joining with the outgoing aperture of the semiconductor laser is reduced by 2 dB (when Δη is −2 dB). From FIG. 10, it will be apparent that the radius r and focal distance f exhibits the relationship of an approximately proportional increase, and the indicator r/f is approximately constant. This demonstrates that the value r/f is appropriate as an indicator that represents the quantity of the intensity of return light joining with the outgoing aperture of the semiconductor laser.

The following describes the fourth embodiment. In this optical module, the indicator d/f will be discussed.

In this case, “d” represents the on-axis thickness of the lens and “f” represents the focal distance. If an optical module is produced with the indicator d/f kept within the range defined by the following conditional expression (2), it is possible to provide an optical module characterized by a compact and lightweight structure, simplified lens production process, simplified assembling and adjustment of the optical module, and minimized impact of the return light.

0.40<d/f<1.3 (2)

The following describes the validity of the conditional expression (2): In the first place, the lower limit of the indicator d/f will be explained. “d” represents the on-axis thickness of the lens. If this is smaller, the lens will be smaller, with the result that the requirements for a more compact and lightweight structure of the optical module can be satisfied more easily. However, there is a limit in the manufacturing technique to reduce the on-axis thickness d of the focal distance f. If the thickness is reduced with a prescribed focal distance f kept unchanged, the entire lens will be reduced in size, and the diameter of the incoming light flux will also be reduced. From the above discussion, it can be concluded that the on-axis thickness d has a lower limit.

If the focal distance f is greater, the optical module will also be greater in size. Thus, to meet the requirements for a more compact and lightweight structure of the optical module, the focal distance f must be set at a level smaller than a prescribed value. Thus, it can be concluded that the focal distance f has an upper limit. From the above discussion, it can be seen that the indicator d/f has a limit when meeting the requirements for a compact and lightweight structure of the optical system and adopting the lens that can be manufactured. To give specific numerical values, it will be appropriate to use a combination wherein the lower limit of d is 1, and the upper limit of f is 2.5. Thus, the lower limit of the indicator d/f is preferably 0.4.

The upper limit of the indicator d/f will be described. If the on-axis thickness d is increased when the focal distance f is a prescribed value, the optical source of the lens on the semiconductor laser side will come closer to the semiconductor laser, so that the WD is reduced. This will make it difficult to assemble and adjust the semiconductor laser and lens, and will raise the assembling and adjustment cost, with the result that productivity will be adversely affected. This shows that the on-axis thickness d has an upper limit. If the focal distance is shorter, the distance between the semiconductor laser and lens will be shortened. This will make it easier to meet the requirements for a more compact and lightweight structure. However, a more compact and lightweight structure will increase the difficulty in assembling and adjustment. This demonstrates that the indicator d/f has a lower limit. From the above discussion, it can be seen that the indicator d/f has a limit when meeting the requirements for easier assembling and adjustment, and compact and lightweight structure of the optical module. To give specific numerical values, it will be appropriate to use a combination wherein the upper limit of the d is 1.5, and the lower limit of the f is 1.2. The indicator d/f is preferably 1.3.

As described above, if an optical module is produced with the indicator d/f kept within the range defined by the conditional expression (2), it is possible to provide an optical module characterized by a compact and lightweight structure, simplified lens production process, simplified assembling and adjustment of the optical module, and minimized impact of the return light.

The following describes the fifth embodiment. The optical module of the present embodiment is generally employed when the light emanating from the light source is collimated for use, or when the light is inputted into other optical parts. A collimating lens is used to collimate the light coming from the semiconductor laser. When the light from the semiconductor laser is to be inputted to other optical parts, one lens can be designed and produced for use. However, when the light emanating from the semiconductor laser is combined with the other optical parts using one lens, it will be difficult to assemble and adjust the semiconductor laser, lens and other optical parts.

When the light emanating from the semiconductor laser is joined to other optical parts using two lenses, the lens adjusting axis can be distributed by two lenses. This allows separate adjustment to be made for each axis, and adjustment of each axis is simplified. Further, when a collimating lens is used as a first lens, the light from the collimating lens is turned into parallel light. This ensures that the lens to be entered next by the outgoing light can be arranged at loose positioning accuracy in the direction of the optical axis.

To remove or reduce the aberration of the light emanating from the semiconductor laser, it is preferred to use an aspherical lens rather than a spherical lens. More preferably, a greater number of aspherical surfaces should be used as optical surfaces. Further, the return light can be reduced by increasing the aspherical surface coefficient so that the curvature in the vicinity of the optical axis will be increased in the direction of convex. In this case, however, there will be an abrupt change in the shape of the optical surface of the lens located higher than the optical axis. This makes it difficult to remove aberration. Thus, preferably, the absolute value of the aspherical surface coefficient A4 for the optical surface of the lens closest to the light source on the light source side does not exceed 5. When the light emanating from the light source is converted to the waveguide using a lens and aberration is removed or reduced using one lens, only two surfaces—incoming and outgoing surfaces—of the lens will be aspherical, and one lens will be used to converge the light diverged from the light source. This requires one lens to have a large refraction capacity. Then, each surface will be so shaped that production is more difficult. This requires the surface-to-surface eccentricity to be minimized, with the result that molding difficulties are raised. Further, the aberration of the lens cannot be corrected, and the efficiency of joining the light with the waveguide will be reduced. In the meantime, when two lenses are used to remove or reduce the aberration, four surfaces are used to remove or reduce the aberration. This arrangement reduces the aberration correction load of each surface, and each surface will be so shaped as to facilitate production. At the same time, the molding difficulty is reduced due to the comparatively increased tolerance of the surface-to-surface eccentricity.

To reduce the light returning from the optical surface of the first lens on the light source side, a spherical lens rather than an aspherical lens is preferably employed. If an aspherical lens is employed, the normal line of the optical surface may face the outgoing aperture of the semiconductor laser, as shown in FIG. 11. This will increase the amount of return light.

As described above, a collimating lens is used as the first lens. This arrangement reduces the difficulty in production, and requirements for assembling and adjustment accuracy will be less severe, whereby high-volume production is improved. Further, use of the aspherical lens as the first lens reduces the light returning to the semiconductor laser.

### EXAMPLES

### Example 1

The first Example will be described. This Example represents the embodiment applicable to all of the above-mentioned first through fifth embodiments. The values shown in the optical system specification data 1 are used to represent the specifications of the optical system. The wavelength of the semiconductor laser is 1.31 μm that is used in the optical communication service. The radius in the light source mode of the optical fiber outgoing aperture is 2 μm. For example, it is possible to assume the case wherein the light emanating from the optical fiber is reflected by the optical surface of the first lens and is fed back to the optical fiber. In such a case, a collimating lens was designed to get the design result shown in the paraxial data 1 and Korenich coefficient/aspherical coefficient data 1. Here, E represents a power of ten. For example, 3.0E−01 represents 0.3. The sag Z (h) of the aspherical shape of such a lens can be expressed by the following Mathematical Formula 1, wherein the optical axial direction is plotted on the horizontal X-axis, and “h” represents the height in the direction perpendicular to the optical axis. “k” represents a Korenich coefficient, and “A₂ᵢ” represents an aspherical coefficient.

$$[ Mathematical Formula 1 ]$$

$$Z ( h ) = \frac{{h}^{2} / r}{1 + \sqrt{1 - ( 1 + k ) {( h / r )}^{2}}} + {\sum }_{i = 2} {A}_{2 i} {h}^{2 i}$$

The on-axis spherical aberration of the designed lens is 1 mλrms, as shown in the design result data 1. This value is sufficiently capable of standing up to commercial use as a collimating lens for use in optical communication services.

The lens used in this Example was aspherical. The lens that can be used is either spherical or aspherical. If there is appropriate agreement in the optical axis between the light source and lens, the light reflected by the optical surface of the lens to return to the outgoing aperture of the optical fiber and to join together again is the light reflected in the vicinity of the optical axis wherein the lens is nearly spherical. Use of an aspherical lens is preferred when the aberration caused by the reflection of the lens is to be reduced, for example, when the light flux after coming out of the lens is joined to the waveguide.

As for specifications, the radius r is positive 0.8 mm, the focal distance f is 1.5 mm that is less than 8 mm, the on-axis thickness of the lens is 1.3 mm, the indicator r/f is 0.53, and indicator d/f is 0.87. These values meet the requirements of the conditional expressions 1 and 2. Confirmation has been made to make sure of the effect of reducing the joining efficiency of the return light at the time of entering the outgoing aperture. Namely, Δη is

−10 dB when the return light joining efficiency is −53.2 dB.

In the optical system specification data 1, the radius in the light source mode represents the radius of the cross section of the light flux at the outgoing aperture entered by the light. To put it more specifically, when a semiconductor laser is used as a light source, the radius in the light source mode represents the radius wherein the light intensity is damped from the maximum light intensity to 1/e² in the distribution of the intensity inside the cross section perpendicular to the optical axis of the light emanating from the outgoing aperture of the light source. When using the light of the light source emanating from the optical fiber, the radius in the light source mode represents the radius wherein the light intensity is damped from the maximum light intensity to 1/e² in the distribution of the intensity inside the cross section perpendicular to the optical axis of the light emanating from the outgoing aperture of the optical fiber.

In the case of the light emanating from the semiconductor laser or optical fiber, the light source NA represents the NA obtained from the outgoing angle of the light whose intensity is damped from the maximum value to 1/e².

The return light joining efficiency n represents the percentage of light emanating from the outgoing aperture that is reflected by the optical surface of the lens to return to the outgoing aperture, when the light emanating from the outgoing aperture is assumed to be reflected 100% by the optical surface of the lens.

Paraxial data 1

| Surface No. | Radius r | On-axis thickness d | Lens material | Remarks |
|---|---|---|---|---|
| 1 | ∞ | 1.7196 | | Light |
| | | | | source |
| 2 | 0.80000 | 1.3000 | BAF5 | Lens |
| 3 | 3.29573 | 0.0000 | | |
| 4 | ∞ | 0.0000 | | |

Korenich Coefficient/Aspherical Surface Coefficient Data 1

Second Surface

k=0.00000E+00, A4=−4.74793E−01, A6=9.97793E−01, A8=−1.62894E+00, A10=0.00000E+00

Third Surface

k=−1.90063E+02, A4=6.11252E−01, A6=−2.04715E+00, A8=1.81598E+01, A10=−2.83363E+01

Optical system specification data 1

| | | |
|---|---|---|
| Wavelength | 1.31 | μm |
| Radius in the light source mode | 2 | μm |
| Light source NA | 0.21 | |
| Lens focal distance f | 1.5 | mm |
| r/f | 0.53 | |
| d/f | 0.87 | |

Design result data 1

| | | |
|---|---|---|
| On-axis spherical aberration (NA = 0.21) | 1 | mλrms |
| Return light joining efficiency η | −53.2 | dB |
| Δη | −10 | dB |

Δη represents the percentage of the return light joining efficiency in the present Example calculated with reference to the return light joining efficiency calculated on the assumption that the optical surface of the lens that reflects the light emanating from the outgoing aperture is flat.

### Example 2

The following describes the second Example. This Example represents the embodiment applicable to all of the above-mentioned first through fifth embodiments. For example, it is possible to assume the case wherein the light emanating from the semiconductor laser is reflected by the optical surface of the first lens and is fed back to the optical fiber. The values shown in the optical system specification data 1 are used to represent the specifications of the optical system. When “Z” is assumed to represent the traveling direction of light, the mode radius in the outgoing aperture is 2 μm in the direction X, and 3 μm in the direction Y. In the semiconductor laser, the light confinement effects are different between the directions X and Y. Thus, the mode radiuses are also different between the directions X and Y. The wavelength of the light source is 1.06 μm. In such a case, a collimating lens was designed to get the design result shown in the paraxial data 2 and Korenich coefficient/aspherical coefficient data 2.

Paraxial data 2

| | | On-axis | | |
|---|---|---|---|---|
| Surface number | Radius r | thickness d | Lens material | Remarks |
| 1 | ∞ | 1.2000 | | Light source |
| 2 | 0.89588 | 1.2000 | BK7 | Lens |
| 3 | −1.36725 | 0.0000 | | |
| 4 | ∞ | 6.6719 | | Position of |
| | | | | convergent |
| | | | | spot |

Korenich Coefficient/Aspherical Surface Coefficient Data 2

Second Surface

k=0.00000E+00, A4=−2.55945E−01, A6=1.56560E−01, A8=0.00000E+00, A10=0.00000E+00

Third Surface

k=−5.40704E+00, A4=−2.47221E−02, A6=4.01418E−01, A8=9.21886E−02, A10=0.00000E+00

Optical system specification data 2

| | | |
|---|---|---|
| Wavelength | 1.06 | μm |
| Radius in the light source mode (X) | 2 | μm |
| Radius in the light source mode (Y) | 3 | μm |
| Light source NA | 0.21 | |
| Lens focal distance f | 1.3 | mm |
| r/f | 0.69 | |
| d/f | 0.92 | |

Design result data 2

| | | |
|---|---|---|
| On-axis spherical aberration (NA = 0.21) | 0 | mλrms |
| Return light joining efficiency η | −44 | dB |
| Δη | −7 | dB |

As shown in the design result data 2, the on-axis spherical aberration of the designed lens is corrected. The radius r is positive 0.9 mm or thereabout, the focal distance f is 13 mm that is less than 8 mm, the on-axis thickness of the lens is 1.2 mm, the indicator r/f is 0.69, and indicator d/f is 0.92. These values meet the requirements of the conditional expressions 1 and 2. Confirmation has been made to make sure of the effect of reducing the joining efficiency of the return light at the time of entering the outgoing aperture. Namely, Δη is −7 dB when the return light joining efficiency is −44.0 dB.

### Example 3

The following describes the third Example. This Example represents the embodiment applicable to all of the above-mentioned first through fifth embodiments. The values shown in the optical system specification data 3 are used to represent the specifications of the optical system. The wavelength of the light source is 1.31 μm that is used in optical communication services. The mode radius of the optical fiber outgoing aperture is 10 μm. For example, it is possible to assume the case wherein the light emanating from the optical fiber is reflected by the optical surface of the first lens and is fed back to the optical fiber. In such a case, a collimating lens was designed to get the design result shown in the paraxial data 3 and Korenich coefficient/aspherical coefficient data 3.

The on-axis spherical aberration of the designed lens is 1 mλrms, as shown in the design result data 2. This value is sufficiently capable of standing up to commercial use as a collimating lens for use in optical communication services. The radius r is positive 2.5 mm or thereabout, the focal distance f is 4.7 mm that is less than 8 mm, the on-axis thickness of the lens is 3.0 mm, the indicator r/f is 0.53, and indicator d/f is 0.63. These values meet the requirements of the conditional expressions 1 and 2.

Paraxial data 3

| | | On-axis | | |
|---|---|---|---|---|
| Surface number | Radius r | thickness d | Lens material | Remarks |
| 1 | ∞ | 5.1478 | | Light source |
| 2 | 2.50000 | 3.0000 | BAF5 | Lens |
| 3 | 13.00000 | 0.0000 | | |
| 4 | ∞ | 0.0000 | | |

Optical system specification data 3

| | | |
|---|---|---|
| Wavelength | 1.31 | μm |
| Radius in the light source mode | 10 | μm |
| Light source NA | 0.04 | |
| Lens focal distance f | 4.7 | mm |
| r/f | 0.53 | |
| d/f | 0.63 | |

Design result data 3

| | | |
|---|---|---|
| On-axis spherical aberration (NA = 0.04) | 1 | mλrms |
| Return light joining efficiency η | −34.5 | dB |
| Δη | −9.7 | dB |

Confirmation has been made to make sure of the effect of reducing the joining efficiency of the return light at the time of entering the outgoing aperture. Namely, Δη is −9.7 dB when the return light joining efficiency is −34.5 dB, as shown in the design result data 3.

### Example 4

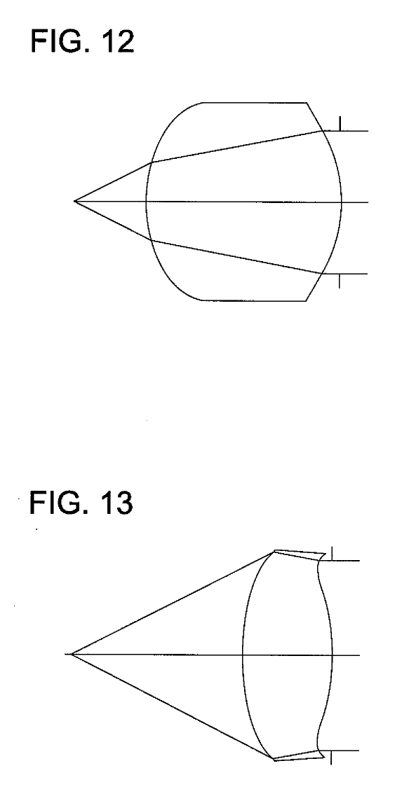

The following describes the fourth Example. This Example represents the embodiment applicable to all of the above-mentioned first through fifth embodiments. For example, it is possible to assume the case wherein the light emanating from the semiconductor laser is reflected by the optical surface of the first lens and is fed back to the optical fiber. The values shown in the optical system specification data 4 are used to represent the specifications of the optical system. It was possible to get the design result shown in the paraxial data 4 and Korenich coefficient/aspherical coefficient data 4. FIG. 12 shows the shape of the designed lens.

Paraxial data 4

| | | On-axis | | |
|---|---|---|---|---|
| Surface number | Radius r | thickness d | Lens material | Remarks |
| 1 | ∞ | 0.5523 | | Light source |
| 2 | 1.00000 | 1.5000 | BAL35 | Lens |
| 3 | −1.01762 | 0.0000 | | |
| 4 | ∞ | 0.0000 | | |

Korenich Coefficient/Aspherical Data 4

Second Surface

k=−5.69047E−01, A4=−7.50264E−01, A6=1.88681E+00, A8.00000E+00, A10=0.00000E+00

Third Surface

k=−1.16292E+00, A4=−2.92320E−02, A6=7.63141E−02, A8=−1.47254E−01, A10=4.25234E−01

Optical system specification data 4

| | | |
|---|---|---|
| Wavelength | 1.06 | μm |
| Radius in the light source mode | 1.5 | μm |
| Light source NA | 0.22 | |
| Lens focal distance f | 1.2 | mm |
| r/f | 0.83 | |
| d/f | 1.25 | |

Design result data 4

| | | |
|---|---|---|
| On-axis spherical aberration (NA = 0.21) | 0 | mλrms |
| Return light joining efficiency η | −42.2 | dB |
| Δη | −3.4 | dB |

As shown in the design result data 4, the on-axis spherical aberration of the designed lens is corrected. The radius r is positive 1.0 mm or thereabout, the focal distance f is 1.2 mm that is less than 8 mm, the on-axis thickness of the lens is 1.5 mm, the indicator r/f is 0.83, and indicator d/f is 1.25. These values meet the requirements of the conditional expressions 1 and 2. Confirmation has been made to make sure of the effect of reducing the joining efficiency of the return light at the time of entering the outgoing aperture. Namely, Δη is −3.4 dB when the return light joining efficiency is −42.2 dB. The indication d/f assumes a value close to the upper limit in the conditional expression (2). Confirmation has been made to make sure of the validity of the upper limit in the conditional expression (2).

### Example 5

The following describes the fifth Example. This Example represents the embodiment applicable to all of the above-mentioned first through fifth embodiments. For example, it is possible to assume the case wherein the light emanating from the semiconductor laser is reflected by the optical surface of the first lens and is fed back to the optical fiber. The values shown in the optical system specification data 5 are used to represent the specifications of the optical system. It was possible to get the design result shown in the paraxial data 5 and Korenich coefficient/aspherical coefficient data 5. FIG. 13 shows the shape of the designed lens.

Paraxial data 5

| | | On-axis | | |
|---|---|---|---|---|
| Surface number | Radius r | thickness d | Lens material | Remarks |
| 1 | ∞ | 2.9526 | | Light source |
| 2 | 4.03290 | 1.5000 | BAL35 | Lens |
| 3 | −3.50000 | 0.0000 | | |
| 4 | ∞ | 0.0000 | | |

Korenich Coefficient/Aspherical Data 5

Second Surface

k=3.37771E+00, A4=−4.18685E−02, A6=2.53548E−02, A8=−3.59249E−03, A10=0.00000E+00

Third Surface

k=−1.86480E+01, A4=−5.92018E−02, A6=3.45907E−02, A8=−1.14758E−02, A10=3.01092E−03

Optical system specification data 5

| | | |
|---|---|---|
| Wavelength | 1.06 | μm |
| Radius in the light source mode | 1.5 | μm |
| Light source NA | 0.22 | |
| Lens focal distance f | 3.5 | mm |
| r/f | 1.15 | |
| d/f | 0.43 | |

Design result data 5

| | | |
|---|---|---|
| Return light joining efficiency (NA = 0.21) | 10 | mλrms |
| Return light joining efficiency η | −57.7 | dB |
| Δη | −4.8 | dB |

As shown in the design result data 5, the on-axis spherical aberration of the designed lens is corrected. The radius r is positive 4.0 mm or thereabout, the focal distance f is 3.5 mm that is less than 8 mm, the on-axis thickness of the lens is 1.5 mm, the indicator r/f is 1.15, and indicator d/f is 0.43. These values meet the requirements of the conditional expressions 1 and 2. Confirmation has been made to make sure of the effect of reducing the joining efficiency of the return light at the time of entering the outgoing aperture. Namely, Δη is −4.8 dB when the return light joining efficiency is −57.7 dB. The indication d/f assumes a value close to the lower limit in the conditional expression (2). Confirmation has been made to make sure of the validity of the lower limit in the conditional expression (2).

1. An optical module comprising a laser light source and at least one lens on which a light emitted from the laser light source enters, wherein an optical axis of the laser light source and an optical axis of the lens approximately agree with each other and, among lenses on which the emitted light enters, a lens on which the emitted light enters first (herein after referred to as “a first lens”) contains an optical surface whose convex surface faces the light source side.

2. The optical module described in claim 1, wherein a distance from an outgoing aperture of the laser light source to the optical surface of the first lens on the laser light source side does not exceed 8 mm.

3. The optical module described in claim 1, wherein the following conditional expression is satisfied where “r” represents a paraxial curvature radius of the optical surface of the first lens on the laser light source side and “f” represents a focal distance of the first lens:
0.50<r/f<6.0 (1).

4. The optical module described in claim 1, wherein the following conditional expression is satisfied where “d” represents an on-axis thickness of the first lens and “f” represents a focal distance of the first lens:
0.40<d/f<1.3 (2).

5. The optical module described in claim 1, wherein the first lens is a collimating lens.

6. The optical module described claim 1, wherein the optical surface of the first lens on the light source side is spherical.

7. An optical unit including:
the optical module described in claim 1; and
a waveguide structure for combining and outputting the laser beams coming out of the optical module.
